(19) United States
(12) Patent Application Publication
(10) Pub. No.: US 2025/0052398 A1
(43) Pub. Date: Feb. 13, 2025

(54) Vehicle with Lighting System

(71) Applicant: Hilo EV Limited, Leigh on Sea, Essex (GB)

(72) Inventors: Ashley May, Leigh on Sea, Essex (GB); Robin Harris, Leigh on Sea, Essex (GB)

(21) Appl. No.: 18/720,277

(22) PCT Filed: Dec. 19, 2022
(86) PCT No.: PCT/GB2022/053295

§ 371 Date: Jun. 14, 2024

(30) Foreign Application Priority Data
Dec. 17, 2021 (GB) 2118405.6

(51) Int. Cl. F21S 43/15; B60L 53/30; B62J 6/04; B62J 6/26; B62J 25/04; F21S 43/31; F21W 107/10

(52) U.S. Cl. CPC F21S 43/15; B60L 53/30; B62J 6/04; B62J 6/26; B62J 25/04; F21S 43/2621; F21S 43/31; B60L 2200/24; F21W 2107/10

(57) ABSTRACT

A wheeled road vehicle has a main body with a front end and a rear end and defining two opposing sides extending between the front end and the rear end. A front wheel is located toward the front end and a rear wheel is located toward the rear end. The vehicle defines a footprint in plan view, the footprint having a front end, a rear end and opposing sides extending between the front end and rear end. The vehicle has a lighting system, the lighting system including one or more light sources for defining a zone of illumination extending along at least a major portion of both sides of the footprint and around the front end of the footprint.

### PRIORITY CLAIM

The present application is a U.S. National Stage patent application of International Patent Application No. PCT/GB2022/053295, filed Dec. 19, 2022, which claims priority to United Kingdom Application No. 2118405.6, filed Dec. 17, 2021, the benefit of which is claimed and the disclosures of which are incorporated herein by reference in their entirety.

### TECHNICAL FIELD

The present invention relates to a wheeled road vehicle having a lighting system, for example an electric scooter or an electric bicycle.

### BACKGROUND

Micromobility vehicles, such as electric scooters and powered bicycles are becoming more popular as people seek alternatives to travelling by car to reduce carbon emissions. Particularly within cities, micromobility vehicles can have the beneficial effect of improving mobility and reducing traffic congestion and pollution for short distance travel.

Nevertheless, concerns about the safety of micromobility vehicles exist and such vehicles are still not permitted for road use in many countries, such as the UK.

There thus exists a need for improvements in safety for micromobility vehicles.

### SUMMARY

According to a first aspect of the disclosure, there is provided a wheeled road vehicle comprising a main body having a front end and a rear end and defining two opposing sides extending between the front end and the rear end, wherein a front wheel is located toward the front end and a rear wheel is located toward the rear end; wherein the vehicle defines a footprint in plan view, the footprint having a front end, a rear end and opposing sides extending between the front end and rear end, further wherein the vehicle comprises a lighting system, the lighting system including one or more light sources for defining a zone of illumination extending along at least a major portion of both sides of the footprint, and around the front end of the footprint.

Advantageously, the provision of a zone of illumination extending along at least a major portion of both sides of the footprint, and around the front end of the footprint, enhances the visibility of the vehicle to other road users. Moreover, the zone of illumination can be used to communicate information regarding the state of the vehicle and/or the situation on the road to the user and/or other road users.

In exemplary embodiments, the vehicle is configured to provide a zone of illumination extending continuously (i.e. unbroken illumination) along at least a major portion of the sides of the footprint, and/or around the front of the footprint. Such zones of ‘continuous’ illumination provide significant illumination to alert other road users to the presence of the vehicle.

Zones of illumination of the kind described herein have been found to be particularly important for vehicles in the form of electric scooters, which are now starting to be seen more commonly on roads in urban areas such as towns and cities. As such, other road users, e.g. those driving cars or motorcycles, are less familiar with seeing electric scooters on roads, and so there is a greater need to alert other road users to the presence of a moving electric scooter to avoid collisions. It will be understood that similar advantages will be attributable to other types of wheeled road vehicle, for example e-bikes.

The term “major portion” should be interpreted to mean a significant proportion of the length of the side, e.g. at least 50%; optionally, greater than 60% of the length of the side; optionally, greater than 70% of the length of the side; optionally, greater than 75% of the length of the side; optionally, greater than 80% of the length of the side.

References to the zone of illumination extending continuously along at least a major portion of both sides of the footprint and around the front end of the footprint herein refers to the fact that the zone of illumination extends continuously along each of the along at least a major portion of both sides of the footprint, as well as continuously around the front end of the footprint. That is, in some embodiments, there is a gap in the zone of illumination in a transition region between the zone of illumination extending along each side of the footprint and the zone of illumination extending along the front of the footprint. In other embodiments, however, the zone of illumination is unbroken between the sides and the front region of the footprint, i.e. the zone of illumination extends as one continuous zone around a major portion of the sides of the front print and the front end of the footprint with no gaps.

In exemplary embodiments, the zone of illumination extends continuously around an entire perimeter of the footprint. Such a configuration provides maximum visibility for the vehicle to other road users, since it also helps to ensure that the zone of illumination can be seen by road users located behind and to the sides of the vehicle.

In exemplary embodiments, the zone of illumination forms, in plan view, an area of uniform illumination which extends along at least a major portion of both sides of the footprint and around the front end of the footprint. Uniform illumination is a more effective visual cue for other road users.

In exemplary embodiments, the area of uniform illumination extends continuously along at least a major portion of both sides of the footprint and around the front end of the footprint. Optionally, the area of uniform illumination extends continuously around an entire perimeter of the footprint. Extending the area of uniform illumination around a greater perimeter of the footprint provides a visual cue for other road users approaching from different directions around the vehicle.

The term “uniform illumination” as used herein refers to the intensity of visible light striking the area being substantially constant over the entire area. In some embodiments this means that a variation in the intensity of visible light of a given wavelength striking the area is no more than about 5%; optionally a variation in the intensity of visible light of a given wavelength striking the area is no more than about 2%; a variation in the intensity of visible light of a given wavelength striking the area is no more than about 1%.

In exemplary embodiments, the vehicle footprint comprises a longitudinal centre axis, wherein, in plan view, the zone of illumination has a perimeter having a front end extending along the front end of the footprint and opposing sides each extending along a respective one of the opposing sides of the footprint, wherein each side of the perimeter describes a line of constant distance from a longitudinal centre axis of the vehicle footprint. In this way, the zone of illumination provides a visual cue of a closest distance around the vehicle which should not be breached by other road users for safety reasons.

In exemplary embodiments, the front end of the perimeter describes a curve of constant radius. In this way, the lighting system also provides a visual cue of a particular distance around the vehicle.

In exemplary embodiments, the perimeter of the zone of illumination has a rear end extending along the rear end of the vehicle footprint, wherein the rear end of the perimeter describes a curve of constant radius. In this way, the zone of illumination also provides a visual cue of a particular distance around the vehicle for other road users approaching from the rear.

In exemplary embodiments, the curves of constant radius described by the front and rear ends of the perimeter of the zone of illumination are centred on the longitudinal centre axis of the footprint. That is, in some embodiments, in plan view, the zone of illumination comprises a stadium or a pill shape centred on the longitudinal centre axis of the footprint.

In exemplary embodiments, each side of the perimeter describes a line of constant distance, D, from the longitudinal centre axis of the vehicle footprint, wherein the radius of each of the curves described by the front and rear ends of the perimeter is also D. The distance D may be set at a recommended safe distance for overtaking vehicles of that type. In some embodiments, the distance may be in the range 1 to 2 metres, for example about 1.5 metres. In this way, the zone of illumination provides a visual cue for other road users of a safety zone around the vehicle which should not be entered.

In exemplary embodiments, the lighting system is configured such that the distance D is adjustable. The adjustability of the extent of the safety zone in this way, allows the user to adapt to changing conditions and thus provides improved safety across a range of conditions.

In exemplary embodiments, the vehicle further comprises a control unit, the control unit being configured to adjust the distance D dependent on one or more conditions relating to an environment in which the vehicle is operated, e.g. relating to a level of darkness and/or precipitation at the time of use of the vehicle. Automating the adjustment of the distance D using the control unit enhances safety as there is no risk of a user forgetting to adjust the distance or setting the distance inappropriately.

In exemplary embodiments, the wheeled road vehicle further comprises one or more sensors, each sensor configured to monitor an input and provide a signal based on the input, and a control system configured to receive the inputs from the one or more sensors; wherein the control unit is part of the control system and wherein the control system is further configured to adjust the distance D if one of the inputs is above or below a predetermined threshold. For example, in some embodiments, the control unit may be configured to adjust the distance D dependent on a detected speed of the vehicle, or of another vehicle on the road, or alternatively dependent on weather data received via GPS or any other suitable communications network. Additionally or alternatively, the distance D can be adjustable manually by a user.

In exemplary embodiments, the lighting system is configured to project light from the one or more light sources onto a running surface over which the road vehicle will travel in use, the lighting system being configured such that, in plan view, the light projected onto the running surface defines a zone of illumination on the running surface which extends around at least a portion of a perimeter of the footprint of the vehicle. Providing the zone of illumination on the running surface enables a more clearly defined zone of illumination, thus providing other road users with a clear visual cue of a safety zone around the vehicle which should not be breached. Optionally, the zone of illumination on the running surface is bounded. That is, the zone of illumination has a finite area. This is in contrast to conventional vehicle illumination systems in which an illuminated area of a road or other running surface extends to infinity. Such a finite zone of illumination may be centred on, or aligned along, the longitudinal centre axis of the footprint. Advantageously, the zone of illumination on the running surface can delimit an area of the running surface that other road users should not enter to maintain a safe distance from the vehicle.

In exemplary embodiments, the footprint of the vehicle may have a front end, rear end and opposing sides extending between the front and rear ends, and the zone of illumination on the running surface may be continuous along at least a major portion of the sides and around the front end. In some of these embodiments, the zone of illumination on the running surface may even be continuous around the entire perimeter of the footprint. Extending the continuous zone of illumination defined on the running surface around the footprint of the vehicle in this way is advantageous because it helps other road users judge a safe distance to maintain from the vehicle from all directions about the vehicle.

In exemplary embodiments, the zone of illumination on the running surface comprises an area of uniform illumination on the running surface, wherein the area of uniform illumination on the running surface extends along at least a major portion of both sides of the footprint and around the front end of the footprint.

In exemplary embodiments, the area of uniform illumination on the running surface extends continuously along at least a major portion of both sides of the footprint and around the front end of the footprint. Optionally, the area of uniform illumination on the running surface extends continuously around an entire perimeter of the footprint.

In exemplary embodiments, the vehicle footprint comprises a longitudinal centre axis, wherein, the zone of illumination on the running surface has a perimeter having a front end extending along the front end of the footprint and opposing sides each extending along a respective one of the opposing sides of the footprint; wherein each side of the perimeter describes a line of constant distance from a longitudinal centre axis of the vehicle footprint. In this way, the zone of illumination on the running surface provides a visual cue as to a closest distance around the vehicle which should not be breached by other road users for safety reasons.

In exemplary embodiments, the front end of the perimeter describes a curve of constant radius.

In exemplary embodiments, the perimeter of the zone of illumination on the running surface comprises a rear end extending along the rear end of the footprint, wherein the rear end of the perimeter describes a curve of constant radius.

Optionally, the curves of constant radius described by the front and rear ends of the perimeter of the zone of illumination on the running surface are centred on the longitudinal centre axis of the footprint. That is, in some embodiments, the zone of illumination on the running surface comprises a stadium or a pill shape centred on the longitudinal centre axis of the footprint.

In exemplary embodiments, each side of the perimeter of the zone of illumination on the running surface describes a line of constant distance, D, from the longitudinal centre axis of the vehicle footprint, wherein the radius of each of the curves described by the front and rear ends of the perimeter of the zone of illumination on the running surface is also D.

In exemplary embodiments, the lighting system is configured such that the distance D is adjustable. The adjustability of the extent of the safety zone in this way, allows the user to adapt to changing conditions and thus provides improved safety across a range of conditions.

In exemplary embodiments, the vehicle further comprises a control unit, the control unit being configured to adjust the distance D dependent on one or more conditions relating to an environment in which the vehicle is operated.

in exemplary embodiments, the wheeled road vehicle further comprises one or more sensors, each sensor configured to monitor an input and provide a signal based on the input, and a control system configured to receive the inputs from the one or more sensors; wherein the control unit is part of the control system and wherein the control system is further configured to adjust the distance D if one of the inputs is above or below a predetermined threshold. For example, in some embodiments, the control unit may be configured to adjust the distance D dependent on a detected speed of the vehicle, or of another vehicle on the road, or alternatively dependent on weather data received via GPS or any other suitable communications network. Additionally or alternatively, the distance D can be adjustable manually by a user.

In exemplary embodiments, the vehicle includes a main body defining front and rear ends of the vehicle, wherein the main body includes a front region extending from the footboard to partially circumscribe the front wheel, further wherein the lighting system is configured to project light onto a running surface over which the road vehicle will travel in use to form the zone of illumination on the running surface and simultaneously illuminate the main body so as to create a zone of illumination on the main body extending continuously around at least a portion of a perimeter of the main body. The provision of two simultaneous zones of illumination is advantageous for a number of reasons. Indeed, whilst the zone of illumination on the running surface serves the purpose of defining the safety zone around the vehicle which other users should not breach, the zone of illumination on the main body enhances the visibility of the main body, and optionally, the operator of the vehicle. Further, the additional zone of illumination can provide additional signalling capacity, for instance to convey information to other road users as described hereinbelow.

In exemplary embodiments, the perimeter of the main body has a front end, a rear end and opposing sides extending between the front end and rear end, wherein the zone of illumination on the main body extends continuously along at least a major portion of both sides of the perimeter and around the front end of the perimeter. Extending the zone of illumination on the main body around the perimeter enhances visibility from a range of directions.

In exemplary embodiments, the zone of illumination extends continuously around an entire perimeter of the main body. Such a configuration provides maximum visibility for the vehicle to other road users, since it also helps to ensure that the zone of illumination can be seen by road users located behind and to the sides of the vehicle.

In exemplary embodiments the zone of illumination formed on the main body is formed by configuring the vehicle to project light from the one or more light sources onto a running surface over which the vehicle will travel in use simultaneously with projecting light from the same one or more light sources towards an eye level for road users. For example, in some embodiments, the main body of the vehicle comprises a reflector arrangement configured to reflect light from the one or more light sources upwards and/or outwards relative to the intended orientation of the vehicle for use to travel on a road or other running surface. In other words, the reflector is configured to reflect light from the one or more light sources in any direction that does not have a downwards component.

In exemplary embodiments, the main body defines at least one groove for receiving an array of light emitting elements. Such a groove may extend along at least a major portion of each side of the main body. Such a groove may extend around at least a major portion of the front of the main body. Such a groove may extend around at least a major portion of the rear of the main body. In exemplary embodiments, the groove extends continuously around at least a major portion of the perimeter of the main body (e.g. along each side of the main body and around the front of the main body). In exemplary embodiments, the lighting system comprises an array of light emitting elements mounted within the or each groove. Providing the array within a groove means that the array is recessed with respect to a surface of the main body. This allows the array to be protected from impacts. Further, the groove provides a convenient means of controlling light projection. That is, the walls of the groove can be used to direct light along a particular desired pathway to create particular visual effects. For example, in some embodiments, the groove is arranged for directing light emitted from the light emitting elements onto the running surface over which the road vehicle will travel in use to define the zone of illumination on the running surface. Optionally, the groove is tilted at an angle θ in the range 20 to 90 degrees to the horizontal when the road vehicle is oriented for use to travel on the running surface, such that light from the light emitting elements is directed outwards from a perimeter of the road vehicle and downwards onto the running surface.

In exemplary embodiments, a height y(x) of the groove above a running surface when the road vehicle is oriented for use to travel on the running surface varies with a position x along a longitudinal axis of the groove. In such embodiments, a luminous flux Φ(x) emit at the array at position x along the groove may vary as a function f(y(x)) of the height y(x) of the groove above the running surface at that position x. For example, the luminous flux Φ(x) emit at the array at position x along the groove may increase as the height y(x) of the groove above the running surface at that position x increases. In this way, the lighting system compensates for the differences in height of the light emitting elements located at different positions along the groove. In some embodiments, the lighting system even provides an area of uniform illumination on the running surface, or at least, an area which is perceived as uniform, even though the light emitting elements are located at different distances from the running surface. An area of uniform illumination provides a more effective visual cue.

Optionally, the function f(y) is defined by the below formula:

ϕ(x)=f(y(x))=A(y(x))²

Where A is a constant.

Since luminous flux varies as an inverse square law with the distance from the source, the luminous flux and luminous intensity at the running surface will decrease approximately in proportion with the inverse of the square of the height of the groove above the running surface. Thus by increasing the luminous intensity emit at the array (ie. the source) in proportion with the square of the height above the running surface, the luminous intensity at the running surface (or the luminous flux striking a unit area of the running surface) can be made to be uniform around the perimeter of the main body.

The different luminous fluxes emit at the array may be accomplished by using LED strips comprising an array of individually addressable LEDs and a controller which is programmed to individually control the luminous flux output by each LED according to the function, as is known in the art.

In exemplary embodiments, a height y(x) of the groove above a running surface when the road vehicle is oriented for use to travel on the running surface varies with a position x along a longitudinal axis of the groove. The angle θ(x) at which the groove is tilted to the horizontal at position x may increase as the height y(x) of the groove above the running surface increases, such that each side of the perimeter describes a line of constant distance D from a longitudinal centre axis of the vehicle footprint. In this way, the zone of illumination enables other road users to visualise a particular distance D around the vehicle, thus helping those road users gauge a safe distance to maintain from the vehicle.

In exemplary embodiments, the front and rear ends of the perimeter each describes a curve of constant radius, D. In this way, the zone of illumination on the running surface enables other road users to visualise a particular distance D around the front and rear of the vehicle.

In exemplary embodiments, the groove is defined by a plurality of recessed surfaces in the main body. In some embodiments, θ(x) is defined as the smallest angle between a mean emission direction of light from the light emitting elements at position x along the longitudinal direction of the groove and the horizontal.

In exemplary embodiments, the lighting system further comprises a lens arrangement. In some of these embodiments, the lens arrangement is arranged to focus light from the groove on to the running surface. The lens arrangement acts to reduce light scattering, thus improving contrast between the zone of illumination on the running surface and the surrounding running surface. This helps to provide a particularly well defined safety zone around the vehicle. The lens arrangement may accordingly be used to compensate for the different heights of the array at different positions x along the longitudinal axis of the groove. For example, refraction at the lens arrangement can be used to bend the light rays from the light emitting elements to ensure that at the running surface light is projected outwardly from the vehicle at a uniform distance around the perimeter of the vehicle. In this way, the size of the zone of illumination on the running surface can be controlled, for instance, to ensure that the zone of illumination reflects a safe distance for other road users to maintain from the vehicle.

In exemplary embodiments, a height y(x) of the groove above a running surface when the road vehicle is oriented for use to travel on the running surface varies with a position x along a longitudinal axis of the groove. In such embodiments, a focal length F(x) of the lens arrangement varies along the longitudinal axis of the groove. For example, in some such embodiments, the focal length F(x) of the lens at a position x along the groove increases as the height y(x) of the groove above a running surface at that position. Optionally, wherein the focal length F(x) of the lens at a position x along the groove increases in proportion to the height y(x) of the groove above a running surface at that position. This allows for effective compensation for the varying height of the groove to ensure that the zone of illumination extends outwards from the vehicle by a constant distance.

The one or more light sources of the invention can comprise any suitable light sources. For example, the lighting system can comprise any of one or more of a LEDs, lasers and diffusers. in exemplary embodiments, the lighting system comprises an LED strip having multiple LED lighting elements in a spaced apart array. Optionally, the LED strip has an outer surface, which is arranged to be flush with a main body of the vehicle. For example, in embodiments in which the main body of the vehicle comprises a groove which extends continuously around a last a major portion of the perimeter of the main body, the LED strip may comprise the array and be arranged within the groove. The groove and LED strip may be configured such that when the LED strip seating within the groove, the LED strip is flush with the main body. In this way the groove provides a recessed surface which enables the flexible strip to be inlaid in the main body, flush with the surface thereof. Arranging the LED strip to be flush with the surface of the main body is advantageous because if the surface of the LED strip were recessed into the surface of the main body dirt particles and other detritus may build up around the strip. On the other hand, if the surface of the LED strip projected out above the surface of the main body, the LED strip would be more prone to damage.

In exemplary embodiments, the main body of the vehicle comprises a reflector arrangement within or arranged within the groove for reflecting light from the one or more light sources upwards and/or outwards; optionally wherein the lighting system and the reflector arrangement are configured to cooperate to create a zone of illumination on the main body extending continuously around at least a portion of a perimeter of the main body.

The inventors have found that when the groove is configured to project light from the array on to the running surface to define a zone of illumination on said running surface, the array itself is no longer visible at an eye level of other road users. The provision of the reflector means that other road users perceive the reflected light as a zone of illumination on the main body. For example, in some embodiments, the zone of illumination on the main body comprises of a band of illumination extending continuously around at least a portion of a perimeter of the main body. Optionally, the band of illumination extends continuously around a major portion of a perimeter of the main body; further wherein the band of illumination extends continuously around the entire perimeter of the major portion of the main body.

In exemplary embodiments, the perimeter of the main body has a front end, a rear end and opposing sides extending between the front end and rear end, wherein the zone of illumination on the main body extends continuously along at least a major portion of both sides of the perimeter and around the front end of the perimeter.

In exemplary embodiments, the zone of illumination extends continuously around an entire perimeter of the main body.

In exemplary embodiments, the main body comprises a recessed surface. The recessed surface may comprise the reflector. Alternatively, the reflector may be bonded to the recessed surface. The reflector may have a reflectance of at least 50% for wavelengths in the visible light spectrum. Optionally, the reflector may have a reflectance of at least 60% for wavelengths in the visible light spectrum. Optionally, the reflector may have a reflectance of at least a reflectance of at least 70% for wavelengths in the visible light spectrum (ie. wavelengths in the range 400 to 700 nm). Optionally the recessed surface has a reflectance of at least 50% over an entirety of the visible light spectrum. Optionally, the reflector comprises one or more of matte aluminium, polished aluminium, polished chrome and polished copper.

In exemplary embodiments, the main body comprises a shell defining front and rear ends of the vehicle, wherein the main body includes a front region extending over and around the front wheel, and a main region, further wherein the groove is defined in the shell. The shell provides a consistent outer surface within which the groove can be provided. Further, because the shell defines the front and rear ends of the vehicle, the groove can be extended around the front and rear ends, in turn meaning that the zone of illumination can be extended around the front and rear ends. This provides better visibility.

In exemplary embodiments, the vehicle is in the form of a scooter of the kind comprising: a footboard for a user to stand on during movement of the vehicle, the footboard having a front end and a rear end; a front wheel toward the front end of the footboard, the front wheel being rotatable relative to said footboard about a first wheel axis; and a rear wheel toward the rear end of the footboard, the rear wheel being rotatable relative to said footboard about a second wheel axis; wherein the front wheel is movable relative to a steering axis for steering the vehicle. Such vehicles may be particularly vulnerable on the road, as vehicles of this type are typically not provided with cages or crumple zones as with cars. The zone of illumination provided by the invention is therefore particularly effective in enhancing the safety of users of vehicles of this type. Indeed, the invention is also effective for other types of micromobility vehicles, such as e-cargo bikes and e-bikes.

In some embodiments, as well as enhancing the visibility of the vehicle, the continuous zone of illumination also conveys information about a changing situation, for instance about a change in state of the vehicle or one of the components thereof, or about a change in state of the environment or another road user.

For example, in exemplary embodiments, the road vehicle of the present invention may be provided with a sensor configured to detect whether an object is within a predefined distance of the road vehicle and send a signal to the control system upon detection of an object within the predefined distance. The vehicle may also comprise a control system configured to adjust an output of the one or more light sources to provide a light signal to road users upon receipt of the signal from the sensor. In this way, the lighting system also acts to provide a visual warning that alerts other road users that they are too close to the vehicle, and reminds them to maintain a safe distance.

Any suitable sensor may be used. For instance, the sensor may comprise a type of proximity sensor, for instance, an inductive proximity sensor or an ultrasonic proximity sensor. In other embodiments, the sensor may comprise a camera or other optical sensor. In such embodiments, the vehicle may additionally comprise an image processing system configured to evaluate information provided by the camera. The image processing system may also be configured to evaluate visual information provided by the camera to assess whether the vehicle is being operated in compliance with local laws/guidelines. For instance, the image processing system may be trained using a machine learning model to recognise when a user breaches local laws, for example, by riding the vehicle on the pavement or pedestrian footpath. When the image processing system detects a breach, it may send a signal to the control system which may adjust an output of the one or more light sources to provide a visual warning to the user that they are breaching local laws.

In embodiments in which the vehicle comprises a motor powered by a battery, the road vehicle may further comprise a control system configured to monitor a voltage across the battery and adjust an output of the light sources if the voltage across the battery is above and/or below a predetermined threshold. In this way, the lighting system may also be used to signal a charge state to a user and thereby alert the user that the battery should be charged.

In some embodiments, the vehicle comprises a control system which is configured to receive a first user input indicative of a manoeuvre to be made by the road vehicle. In these embodiments, the control system may be further configured to adjust an output of the one or more light sources upon receipt of the first user input to thereby provide a light signal which warns other road users of the intended manoeuvre. Accordingly, as well as enhancing the visibility of the vehicle, the lighting system is simultaneously used as an indicator, further enhancing the safety of road users. The skilled person would be aware of numerous means for generating user inputs to indicate a manoeuvre to be made by the road vehicle. For instance, in some embodiments, the vehicle comprises a manual switch configured to be operated by the user when they intend to perform a certain manoeuvre, for example turning left or right. In some embodiments, for instance, matching manually operated switches may be provided on both left and right handlebars to enable the user to indicate that they intend to turn left or right. Alternatively, the vehicle may be configured to automatically sense that the user is proceeding to turn left or right and subsequently send a signal to the control system. In such embodiments, the vehicle may comprise one or more sensors arranged on the steering column and configured to sense an angular displacement the same. The sensor may then generate a signal when the angular displacement in one direction is sensed to be greater than a certain threshold. The sensor then sends a signal to the control system indicative of the fact that the vehicle is turning in that direction. The vehicle may also comprise a speedometer which generates a signal indicative of the speed of the vehicle. The control system may be configured to adjust an output of the light sources to provide a light signal indicative of a turning manoeuvre only if the speed of the vehicle is above a certain threshold. In this way, turning signals will not be generated unnecessarily if the steering column is moved whilst the vehicle is stationary. In some embodiments, the control system is additionally configured to interface with a wireless network such as Bluetooth® to connect with an accessory comprising its own lighting system. The control system may then be configured to send a signal to the accessory to indicate that the user is performing a manoeuvre. A controller on the accessory can then adjust an illumination of one or more lighting sources in the accessory lighting system. The accessory may, for instance, comprise a smart helmet, or rucksack.

Additionally or alternatively, the road vehicle comprises: one or more sensors, each sensor configured to monitor an input and provide a signal based on the input; and a control system including a diagnostic circuit configured to receive the inputs from the one or more sensors. The control system may be further configured to adjust an output of the one or more light sources if one of the inputs is above or below a predetermined threshold to provide a light signal to a user. The input being above or below the predetermined threshold may be indicative of a fault, or abnormality, in one or more components of the vehicle. The change in the output of the one or more light sources may thus signal to a user that there is a fault with the vehicle and indicate that the vehicle should be serviced. Accordingly, the user can avoid operating the vehicle in a faulty, and potentially dangerous, condition, perhaps leading to vehicle breakdown. Moreover, optimum maintenance of the vehicle is facilitated.

The skilled person would be aware of numerous sensors that could be used to provide an indication of whether the vehicle components are operating normally. For instance, the vehicle may comprise one or more of: a temperature sensor configured to monitor a temperature of a motor, a temperature sensor configured to monitor a temperature of a battery; an accelerometer; a break pressure sensor, a voltmeter, an ammeter, etc. The accelerometer may provide a vibration signal which the diagnostic circuit can evaluate to identify abnormal vibrations indicative of a faulty component. A voltmeter and/or ammeter can be used to identify short circuits and/or check power usage by electrical components in the vehicle.

In some embodiments, the wheeled road vehicle may be configured to connect to a docking system. In such embodiments the vehicle may be a motorised vehicle including an electric motor powered by a battery, and the docking system may be configured to provide power to the vehicle to charge the battery. For this purpose, the docking system may comprise an electrical outlet and the vehicle may comprise an electrical terminal which is electrically connected to the battery and configured to connect to the electrical outlet. Electrical power is then delivered through the electrical outlet to charge the battery. Optionally, the vehicle may comprise a control system configured to detect that the road vehicle has been connected to the docking system and adjust an output of the one or more light sources to signal to a user that the road vehicle is connected to the docking system. In this way, the lighting system provides a visual signal as to whether the vehicle is properly connected to the docking system, for instance, whether the battery is charging as intended.

In some embodiments, the one or more light sources comprise an array of light emitting elements. In such embodiments, the control system may be configured to adjust an output of each light emitting element in the array independently of the other light emitting elements in the array. This provides greater variability in the output of the lighting system.

In some embodiments, adjusting an output of the one or more light sources may involve at least one of adjusting a brightness of the one or more light sources and changing a colour of light emit from the one or more light sources. Additionally or alternatively, the one or more light sources may be configured to flash at regular time intervals. In such embodiments, adjusting an output of the one or more light sources may involve adjusting the time intervals between flashes and/or the duration of a flash. In some embodiments, adjusting an output of the one or more light sources may involve adjusting more than one of: a brightness, a colour and an interval between flashes simultaneously.

In some embodiments, the lighting system comprises an array of light emitting elements arranged about at least a major portion of the perimeter of the handlebar. The handlebar may define a groove which extends around at least a major portion of the perimeter of the handlebar. The array may be provided within the groove.

Optionally, the vehicle includes a storage box releasably mountable on the steering column; optionally, wherein the vehicle is battery powered, and wherein the vehicle is configured to supply power from a battery to the storage box when the storage box is connected to the steering column; optionally wherein the storage box is configured to use the power for heating or refrigeration of items to be located in the storage box.

In exemplary embodiments, the lighting system may be used to visually announce that the vehicle is in use to deliver a particular service. For example, the one or more light sources of the lighting system may be configured to emit light according to a colour scheme or pattern which is associated with a particular service, for example an emergency service, to announce to road users and pedestrians that the vehicle is in use by that service. For example, in the UK, the lighting system may be configured to emit blue light to signal that the vehicle belongs to the emergency services. The lighting system may also be configured to flash intermittently to signal that the vehicle belong to the emergency services. Various systems and arrangements can be conceived for giving a particular visual effect which is associated with a particular service. For instance, in embodiments which comprise a light emitting array mounted within a groove in the main body of the vehicle, adjacent portions of the array may be sequentially illuminated using green light to give the appearance of a green light which travels continuously around a perimeter of the main body. Such a light pattern may alert road users and pedestrians that the vehicle is being used by a doctor on an emergency call. In this way, road users can act appropriately, for instance to allow the vehicle to pass.

According to a second aspect of the disclosure, there is provided a docking system configured to connect to a road vehicle as described hereinabove. Optionally, the docking system is comprised within a motor vehicle, for example an automobile.

According to a third aspect of the disclosure there is provided a vehicle with a docking station for an electric scooter for charging the electric scooter, wherein the docking station is configured for charging the electric scooter; optionally wherein, the electric scooter is a vehicle in accordance with the first aspect of the disclosure.

In some embodiments, the vehicle with the docking system is a motor vehicle, for example an automobile. Alternatively, the vehicle may be a rail vehicle such as a train or a tram. In other embodiments, the vehicle could be a watercraft, such as a ship or a boat.

In embodiments in which the docking station is provided in a motor vehicle, the docking station is located in a storage compartment of the motor vehicle, such as the boot or ‘trunk’ of the motor vehicle.

According to a fourth aspect of the disclosure, there is provided a wheeled road vehicle comprising a main body having a front end and a rear end, wherein a front wheel is located toward the front end and a rear wheel is located toward the rear end; a steering assembly comprising a steering column having a handlebar; and a lighting system, the lighting system including one or more light sources for defining a zone of illumination around at least a portion of the handlebar. As well as enhancing the visibility of the scooter, the continuous zone of illumination may also be used to communicate various information regarding the state of the vehicle and/or the situation on the road. Optionally, the road vehicle also comprises a footboard for a user to stand on during movement of the vehicle.

Optionally the handlebar has a front-facing side and the continuous zone of illumination extends along a major portion of the front-facing side. Further optionally, the continuous zone of illumination extends along the entirety of the front-facing side. Further optionally, the handlebar may have first and second lateral sides and the continuous zone of illumination may extend along a portion of each of the first and second lateral sides. Further optionally, the continuous zone of illumination may extend along substantially an entirety of the front-facing side and the first and second lateral sides. Further optionally, the handlebar has a rear-facing side and the continuous zone of illumination extends at least partially along said rear-facing side. Extending the continuous zone of illumination around the handlebar improves the visibility-enhancing effect and allows light from the light sources to be seen by more road users around the vehicle.

In some embodiments, the road vehicle is a motorised vehicle comprising a motor powered by a battery. In such embodiments, the vehicle may be configured for supplying power to the lighting system form the battery.

In some embodiments, as well as enhancing the visibility of the vehicle, the continuous zone of illumination also conveys information about a changing situation, for instance about a change in state of the vehicle or one of the components thereof, or about a change in state of the environment or another road user.

For example, the road vehicle of the present invention may be provided with a sensor configured to detect whether an object is within a predefined distance of the road vehicle and send a signal to the control system upon detection of an object within the predefined distance. The vehicle may also comprise a control system configured to adjust an output of the one or more light sources to provide a light signal to road users upon receipt of the signal from the sensor. In this way, the lighting system also acts to provide a visual warning that alerts other road users that they are too close to the vehicle, and reminds them to maintain a safe distance.

Any suitable sensor may be used. For instance, the sensor may comprise a type of proximity sensor, for instance, an inductive proximity sensor or an ultrasonic proximity sensor. In other embodiments, the sensor may comprise a camera or other optical sensor. In such embodiments, the vehicle may additionally comprise an image processing system configured to evaluate information provided by the camera. The image processing system may also be configured to evaluate visual information provided by the camera to assess whether the vehicle is being operated in compliance with local laws/guidelines. For instance, the image processing system may be trained using a machine learning model to recognise when a user breaches local laws, for example, by riding the vehicle on the pavement or pedestrian footpath. When the image processing system detects a breach, it may send a signal to the control system which may adjust an output of the one or more light sources to provide a visual warning to the user that they are breaching local laws.

In embodiments in which the vehicle comprises a motor powered by a battery, the road vehicle may further comprise a control system configured to monitor a voltage across the battery and adjust an output of the light sources if the voltage across the battery is above and/or below a predetermined threshold. In this way, the lighting system may also be used to signal a charge state to a user and thereby alert the user that the battery should be charged.

In some embodiments, the vehicle comprises a control system which is configured to receive a first user input indicative of a manoeuvre to be made by the road vehicle. In these embodiments, the control system may be further configured to adjust an output of the one or more light sources upon receipt of the first user input to thereby provide a light signal which warns other road users of the intended manoeuvre. Accordingly, as well as enhancing the visibility of the vehicle, the lighting system is simultaneously used as an indicator, further enhancing the safety of road users. The skilled person would be aware of numerous means for generating user inputs to indicate a manoeuvre to be made by the road vehicle. For instance, in some embodiments, the vehicle comprises a manual switch configured to be operated by the user when they intend to perform a certain manoeuvre, for example turning left or right. In some embodiments, for instance, matching manually operated switches may be provided on both left and right handlebars to enable the user to indicate that they intend to turn left or right. Alternatively, the vehicle may be configured to automatically sense that the user is proceeding to turn left or right and subsequently send a signal to the control system. In such embodiments, the vehicle may comprise one or more sensors arranged on the steering column and configured to sense an angular displacement the same. The sensor may then generate a signal when the angular displacement in one direction is sensed to be greater than a certain threshold. The sensor then sends a signal to the control system indicative of the fact that the vehicle is turning in that direction. The vehicle may also comprise a speedometer which generates a signal indicative of the speed of the vehicle. The control system may be configured to adjust an output of the light sources to provide a light signal indicative of a turning manoeuvre only if the speed of the vehicle is above a certain threshold. In this way, turning signals will not be generated unnecessarily if the steering column is moved whilst the vehicle is stationary. In some embodiments, the control system is additionally configured to interface with a wireless network such as Bluetooth® to connect with an accessory comprising its own lighting system. The control system may then be configured to send a signal to the accessory to indicate that the user is performing a manoeuvre. A controller on the accessory can then adjust an illumination of one or more lighting sources in the accessory lighting system. The accessory may, for instance, comprise a smart helmet, or rucksack.

Additionally or alternatively, the road vehicle may comprise: one or more sensors, each sensor configured to monitor an input and provide a signal based on the input; and a control system including a diagnostic circuit configured to receive the inputs from the one or more sensors. The control system may be further configured to adjust an output of the one or more light sources if one of the inputs is above or below a predetermined threshold to provide a light signal to a user. The input being above or below the predetermined threshold may be indicative of a fault, or abnormality, in one or more components of the vehicle. The change in the output of the one or more light sources may thus signal to a user that there is a fault with the vehicle and indicate that the vehicle should be serviced. Accordingly, the user can avoid operating the vehicle in a faulty, and potentially dangerous, condition, perhaps leading to vehicle breakdown. Moreover, optimum maintenance of the vehicle is facilitated.

The skilled person would be aware of numerous sensors that could be used to provide an indication of whether the vehicle components are operating normally. For instance, the vehicle may comprise one or more of: a temperature sensor configured to monitor a temperature of a motor, a temperature sensor configured to monitor a temperature of a battery; an accelerometer; a break pressure sensor, a voltmeter, an ammeter, etc. The accelerometer may provide a vibration signal which the diagnostic circuit can evaluate to identify abnormal vibrations indicative of a faulty component. A voltmeter and/or ammeter can be used to identify short circuits and/or check power usage by electrical components in the vehicle.

In some embodiments, the wheeled road vehicle may be configured to connect to a docking system. In such embodiments the vehicle may be a motorised vehicle including an electric motor powered by a battery, and the docking system may be configured to provide power to the vehicle to charge the battery. For this purpose, the docking system may comprise an electrical outlet and the vehicle may comprise an electrical terminal which is electrically connected to the battery and configured to connect to the electrical outlet. Electrical power is then delivered through the electrical outlet to charge the battery. Optionally, the vehicle may comprise a control system configured to detect that the road vehicle has been connected to the docking system and adjust an output of the one or more light sources to signal to a user that the road vehicle is connected to the docking system. In this way, the lighting system provides a visual signal as to whether the vehicle is properly connected to the docking system, for instance, whether the battery is charging as intended.

In some embodiments, the one or more light sources comprise an array of light emitting elements. In such embodiments, the control system may be configured to adjust an output of each light emitting element in the array independently of the other light emitting elements in the array. This provides greater variability in the output of the lighting system.

In some embodiments, adjusting an output of the one or more light sources may involve at least one of adjusting a brightness of the one or more light sources and changing a colour of light emit from the one or more light sources. Additionally or alternatively, the one or more light sources may be configured to flash at regular time intervals. In such embodiments, adjusting an output of the one or more light sources may involve adjusting the time intervals between flashes and/or the duration of a flash. In some embodiments, adjusting an output of the one or more light sources may involve adjusting more than one of: a brightness, a colour and an interval between flashes simultaneously.

In some embodiments, the lighting system comprises an array of light emitting elements arranged about at least a major portion of the perimeter of the handlebar. The handlebar may define a groove which extends around at least a major portion of the perimeter of the handlebar. The array may be provided within the groove.

In some embodiments, the lighting system comprises one or more LED strips, each having multiple LED lighting elements in a spaced apart array. Optionally, the one or more LED strips have an outer surface which is arranged to be flush with a main body of the vehicle. For example, in embodiments in which the main body of the vehicle comprises a groove which extends around a last a major portion of the perimeter of the main body, the LED strip may comprise the array and be arranged within the groove. The groove and LED strip may be configured such that when the one or more LED strips are seated within the groove, the LED strips are flush with the main body. In this way the groove provides a recessed surface which enables the flexible strip to be inlaid in the main body, flush with the surface thereof.

Arranging the LED strip to be flush with the surface of the main body is advantageous because if the surface of the LED strip were recessed into the surface of the main body, dirt particles and other detritus may build up around the strip. On the other hand, if the surface of the LED strip projected out above the surface of the main body, the LED strip would be more prone to damage.

In some embodiments, the road vehicle may comprise: a footboard for a user to stand on during movement of the vehicle, the footboard having a front end and a rear end. In these embodiments, the front wheel may be toward the front end of the footboard, and be rotatable relative to said footboard about a first wheel axis; and the rear wheel may be toward the rear end of the footboard, and be rotatable relative to said footboard about a second wheel axis.

According to a fourth aspect of the present invention, there is provided a wheeled road vehicle comprising a main body having a front end and a rear end and defining two opposing sides extending between the front end and the rear end, wherein a front wheel is located toward the front end and a rear wheel is located toward the rear end; further wherein the vehicle comprises a lighting system, the lighting system including one or more light sources for defining a zone of illumination extending continuously around one or more of at least a portion of a perimeter of the main body, for indicating the position of the vehicle. Any of the features described hereinabove in relation to the first aspect of the disclosure may be implemented in third aspect.

In exemplary embodiments, the zone of illumination extends continuously around an entire perimeter of the footprint. Such a configuration provides maximum visibility for the vehicle to other road users, since it also helps to ensure that the zone of illumination can be seen by road users located behind and to the sides of the vehicle.

In exemplary embodiments, the perimeter of the main body has a front end, a rear end and opposing sides extending between the front end and rear end, wherein the zone of illumination extends continuously along at least a major portion of both sides of the perimeter and around the front end of the perimeter.

Providing continuous illumination along at least a major portion of the sides of the perimeter, as well as around the front of the perimeter provides significant illumination alert other road users to the presence of the vehicle. The term “major portion” should be interpreted to mean a significant proportion of the length of the side, e.g. at least 50%; optionally, greater than 60% of the length of the side; optionally, greater than 70% of the length of the side; optionally, greater than 75% of the length of the side; optionally, greater than 80% of the length of the side.

In exemplary embodiments, the zone of illumination extends continuously around an entire perimeter of the main body. Such a configuration provides maximum visibility for the vehicle to other road users, since it also helps to ensure that the zone of illumination can be seen by road users located behind and to the sides of the vehicle.

### BRIEF DESCRIPTION OF THE FIGURES

The present invention will now be described, by way of example, with reference to the below figures in which:

FIG. 1 is a perspective view of a vehicle according to a first aspect of the present invention;

FIG. 2 is another perspective view of the vehicle of FIG. 1;

FIGS. 3A, 3B and 3C schematically depict how light from the lighting system of the vehicle of FIG. 1 is perceived by road users;

FIG. 4 is a plan view of the vehicle of FIG. 1 from above;

FIG. 5 is a partial perspective view of a lower portion of the vehicle of FIG. 1 from the front;

FIG. 6 is a side view of the vehicle of FIG. 1 in a stowed configuration;

FIG. 7 is a partial cross-section along the plane B-B of FIG. 6

FIG. 8 is an enlarged view along the plane A-A of FIG. 6;

FIG. 9 is a partial perspective view of a lower portion of the vehicle of FIG. 1;

FIG. 10 is a top view of the vehicle of FIG. 1;

FIG. 11 is a perspective view of the vehicle of FIG. 1 docked in a docking system according to the invention;

FIG. 12 is an enlarged side view of the docking system of FIG. 11;

FIG. 13 is a cross-sectional view of the vehicle and docking system of FIG. 11;

FIG. 14 is an enlarged cross-sectional view of a front portion of the vehicle in FIG. 9;

FIG. 15 is a view from above of a handlebar of the vehicle of FIG. 1;

FIG. 16 is an exploded view of an image processing system arranged in a steering column of the vehicle of FIG. 1;

FIG. 17 is a view of a rear portion of the vehicle of FIG. 1 showing a rear camera;

FIGS. 18A-C are perspective views of the vehicle of FIG. 1 with various accessories;

FIG. 19 is a front view of the vehicle of FIG. 1 in a stowed configuration;

FIG. 20 is a perspective view of alternative embodiment of the vehicle invention; and

FIG. 21 is a perspective view of a further alternative embodiment of the invention.

### DETAILED DESCRIPTION OF THE FIGURES

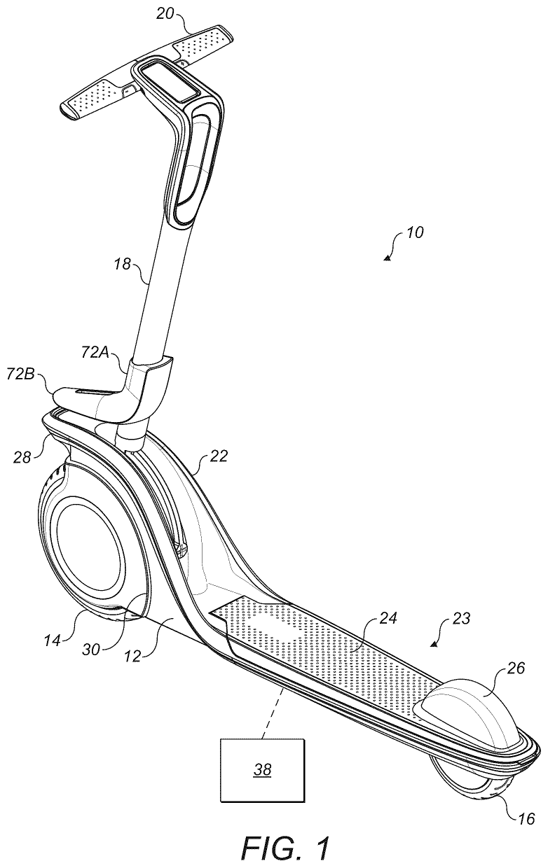

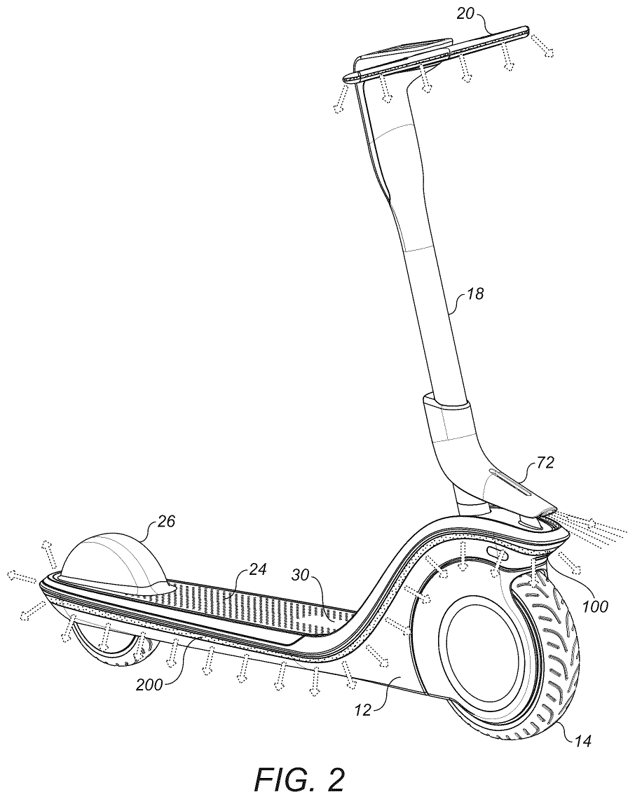

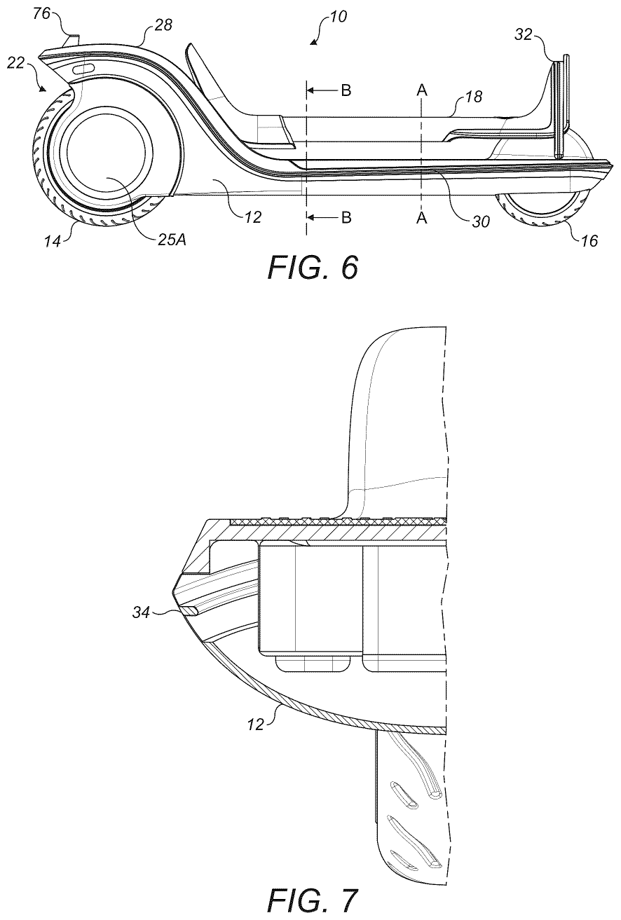

Referring to FIGS. 1 to 2, there is shown a vehicle 10. The vehicle 10 is a battery-powered electric scooter including a main body 12, a front wheel 14, a rear wheel 16, and a steering column 18 having a handlebar 20. The main body 12 includes a front region 22 which extends over the front wheel 14, and a main region 23 which extends rearward beyond the rear wheel 16 and encircles the rear wheel 16. The main region 23 of the main body 22 includes a footboard 24 for a user to stand on during movement of the vehicle 10, and a rear splashguard 26 which partially covers the rear wheel 16. The front region 22 includes a front extension 28 which extends forward from the footboard 24 and partially encircles the front wheel 14 to form a splashguard to protect a user from splashes from the front wheel 14. The steering column 18 is configured to pivot about the main body 12 from a steering position (FIGS. 1 and 2) to a stowed position (FIG. 6).

The scooter additionally includes a main body lighting system and a handlebar lighting system, as will be described in more detail below.

A control module 38 (shown schematically) is housed within the main body 12 and configured for controlling various aspects of the operation of the vehicle 10, as will be described in more detail below.

The front wheel 14 of the scooter is driven by an electric motor (not shown) which is powered by a battery pack 44 housed in a compartment beneath the footboard 24, as will be described in more detail below. The battery pack 44 also powers the lighting systems and a control module 38.

Referring now to FIGS. 1 to 5, the arrangement of the lighting systems will be described in more detail.

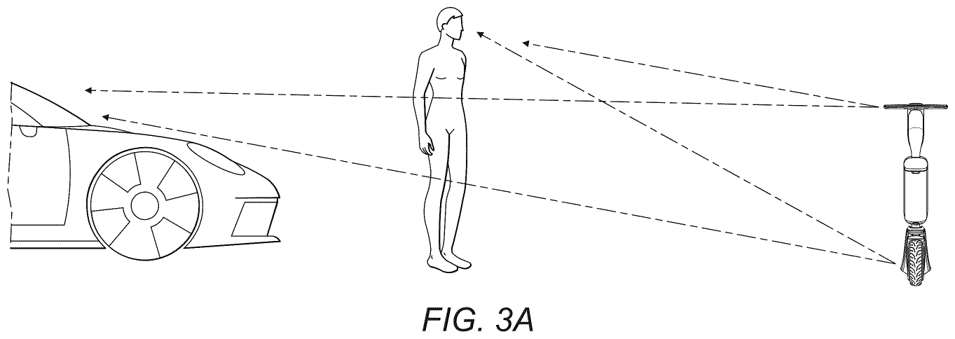

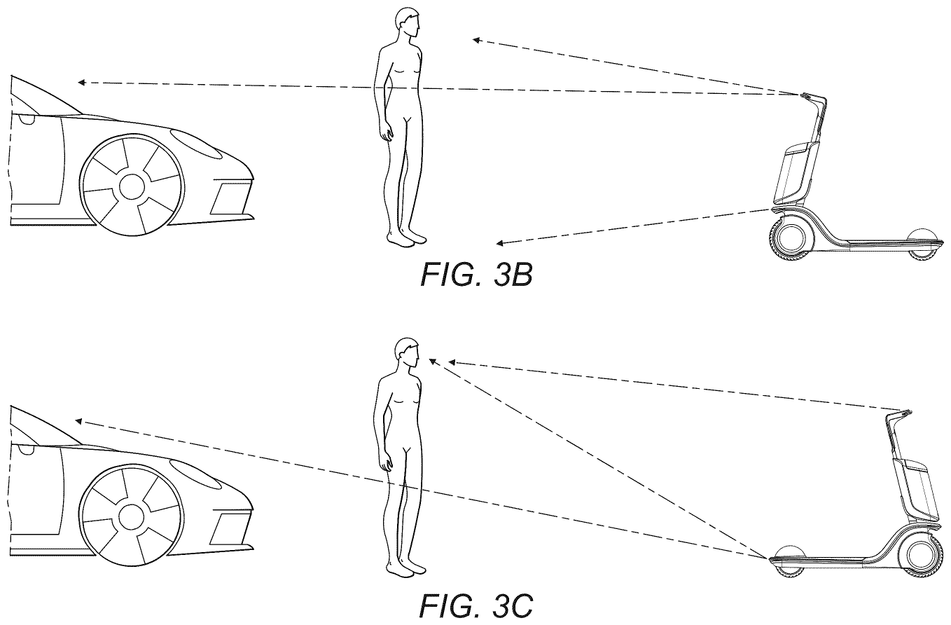

The main body lighting system is perceived by road users both as a band of illumination 100 extending continuously around an entire perimeter of the main body 22 and as a continuous zone of illumination 200 on the running surface. Arrows in FIG. 2 schematically show light propagating from the main body lighting system to form the continuous zone of illumination 200 on the running surface. Arrows in FIGS. 3A to 3C schematically show light propagating from the main body lighting system to form the band of illumination 100 around a perimeter of the main body 22.

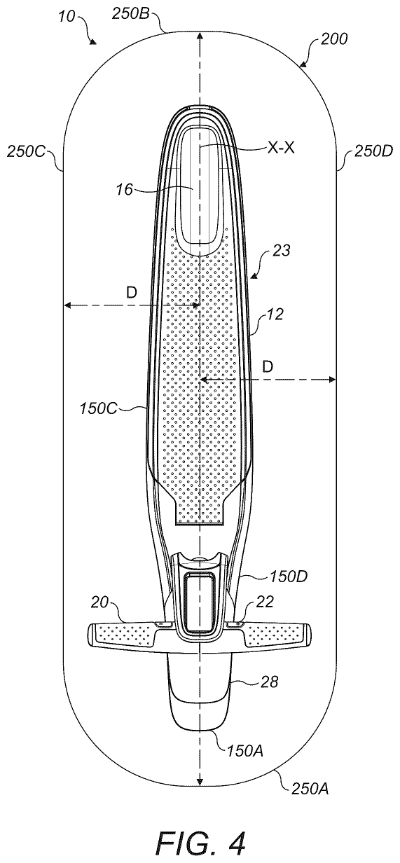

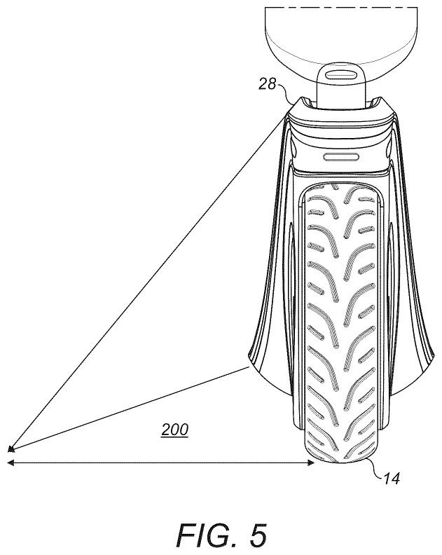

Referring to FIGS. 2 and 5, the continuous zone of illumination 200 on the running surface appears as an area of uniform illumination on the running surface. As can be seen in FIG. 4, the area of uniform illumination formed by the continuous zone of illumination 200 extends around the perimeter of the footprint of the vehicle. The continuous zone of illumination 200 is sized to demarcate a safety zone around the vehicle 10 which other road users should not enter in order to maintain a safe distance from the vehicle 10. Specifically, the continuous zone of illumination 200 has a perimeter having a front end 250A extending along a front end 150A of the footprint, a rear end 150B extending along the rear end 150B of the footprint and opposing sides 250C,250D each extending along a respective one of the opposing sides 150C, 150D of the footprint. Each side 250C,250D of the perimeter describes a line of constant distance, D, from a longitudinal centre axis X-X of the vehicle footprint. The front and rear ends 250A, 250B each describe a curve centred on the longitudinal axis X-X and having constant radius D. As such, the perimeter of the continuous zone of illumination 200 visually demonstrates a distance D. Distance D is set at a recommended distance which other road users should maintain from the vehicle for safety reasons.

Referring now to FIGS. 5 to 8, the configuration of the main body lighting system will now be described. The main body lighting system includes a flexible LED strip 30 that extends around the entire perimeter of the main body 12. The LED strip is received in a groove 34 defined in the main body 12 which groove 34 extends around an entire perimeter of the main body 12. The groove 34 is configured such that light projects down on to the running surface of the scooter, as will be described in detail below, and thereby defines a continuous zone of illumination 200 on the running surface around the perimeter of the vehicle footprint. The LED strip is affixed by double-sided adhesive tape, adhesive, screws, clips or any other suitable means.

The LED strip includes a flexible printed circuit board including an LED light circuit having a plurality of spaced-apart RGB LEDs, and a flexible plastic cover encapsulating the LEDs. The LED strip also includes a controller configured to control the colour and intensity of light output by the LEDs. The LED light circuit is configured so that the LED lights are individually controllable by the controller.

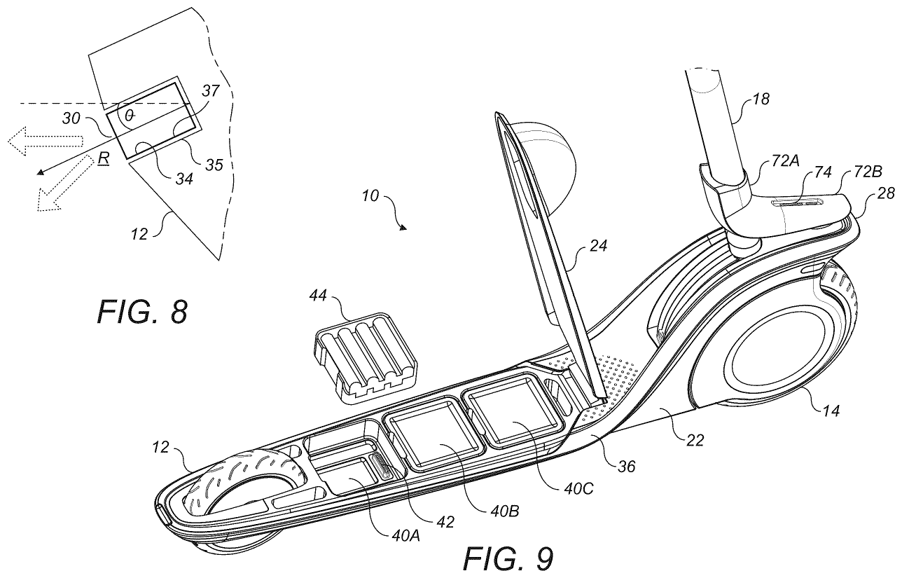

FIG. 8 shows an enlarged view along the plane A-A in FIG. 6. It can also be seen that the groove 34 is oriented in the main body 12 such that a mean emission direction of light emit at the array (indicated by the arrow labelled R in FIG. 8) is tilted at an angle θ of approximately 30° from the horizontal (indicated by the dashed line in FIG. 8). In this way, light from the LEDs is projected downwards onto a running surface of the vehicle 10 and laterally outwards from the longitudinal centre axis by distance D. The LED strip is arranged in the groove 34 such that the exposed surface of the LED strip is flush with the surface of the main body 12.

Referring again to FIG. 2 it is seen that the height of the groove 34 above the running surface varies along the longitudinal direction of the groove 34. For instance, the height of the groove 34 above the running surface is at a minimum around the main region 23 including the footboard 24 and encircling the rear wheel 16, but that the height increases around the front region 22 and is at a maximum directly above the front wheel 14. In order to ensure that light is projected to a uniform distance D around the perimeter of the footprint the angle of tilt θ of the groove 34 is adjusted to compensate for the height differences. In particular, as the height of the groove 43 increases along the front region 22, the angle of tilt θ increases. In this way, light emit at points along the array which are higher up, which would otherwise have spread out and diverged more at the running surface, is directed closer to the perimeter of the footprint.

Additional measures are also used to compensate for differences in height of the LEDs (and therefore different distances from the running surface) for LEDs arranged at different positions along the groove 34 to provide an area of uniform illumination. Specifically, the controller of the LED strip is programmed to control the luminous flux of light emitted from a given LED as a function of the height of the groove 34 at the position along the groove in which that given LED is located. The controller controls the luminous flux by increasing the power delivered to LEDs arranged at positions along the groove 34 which are higher up above the running surface. Thus, LEDs arranged on the strip at positions along the groove 34 which are higher up will emit a greater luminous flux. Mathematically, the luminous flux Φ(x) emit by an LED at position x along the groove 34 may be expressed as a function f(y(x)) of the height y(x) of the groove above the running surface at position x having the below formula:

ϕ(x)=f(y(x))=A(y(x))²

Where A is a constant.

Since the luminous flux striking a surface is inversely proportional to the distance from the source, the above function means that the luminous flux striking the running surface from the LEDs appears to be uniform to the human eye.

Referring back to FIG. 8, the main body 12 of the vehicle 10 is provided with a reflector arrangement 37 configured to reflect light from the LEDs upwards and outwards. The reflector arrangement 37 comprises a strip of reflective material which is arranged along a lower recessed surface 35 within the groove 34. Specifically, the reflector arrangement 37 comprises a strip of aluminium which is bonded or otherwise fixed onto lower recessed surface 35 to provide the reflector 37.

Referring back to FIGS. 3A to 3C, configuring the reflector arrangement 37 to reflect light from the LED strip upwards towards an eye level of road users forms the band of illumination 100 around the perimeter of the main body 12. Accordingly, whilst the angled groove 34 means that light from the LEDs is emit in a downwards direction to form the continuous zone of illumination 200 on the running surface, the reflector arrangement is arranged to cooperate with the lighting system to reflect light at an eye level for road users. This gives the groove 34 the appearance of being illuminated, thereby forming the band of illumination 100 around the perimeter of the main body 12.

Like the main body lighting system, the handlebar lighting system also includes LED strips comprising a flexible printed circuit board including an LED light circuit having a plurality of spaced-apart RGB LEDs, and a flexible plastic cover encapsulating the LEDs. As with the main body lighting system, the LED strip in the handlebar lighting system also includes a controller configured to control the colour and intensity of light output by each LED independently.

The handlebar lighting system comprises a separate LED strip 32A,32B for each handle of the handlebar 20. Each LED strip of the handlebar 20 lighting system extends along a respective side edge of the handlebar 20 and along half of the front facing edge. The LED strips of the handlebar lighting system are similarly received in grooves 34 in the handlebar 20 such that the exposed surfaces of the flexible plastic housings are flush with the surface of the handlebar 20.

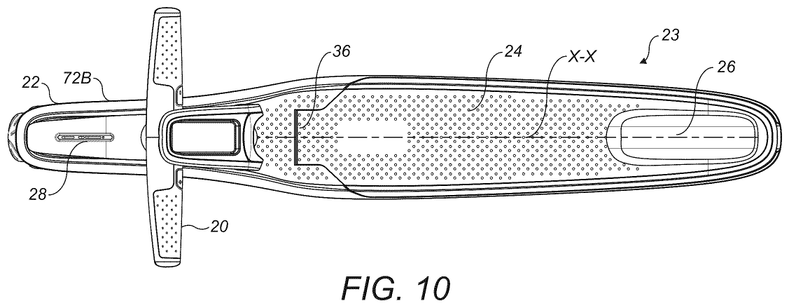

Referring now to FIGS. 9 and 10, the arrangement of electrical components in the compartment beneath the footboard 24 will be described. As can be seen in FIG. 9, the footboard 24 of the vehicle 10 is mounted on the main body 12 via a hinge 36 at the forward longitudinal end of the footboard 24. The footboard 24 can therefore be lifted up and pivoted about the main body 12 to access the compartment in the main body 12. A fingerhold is conveniently provided at the rear longitudinal end to allow a user to gain purchase on the footboard 24.

Referring to FIG. 9, the compartment comprises three battery pack mounting recesses 40 arranged along the longitudinal direction of the main body 12. The three battery pack mounting recesses comprise a front mounting recess 40A, a middle mounting recess 40B and a rear mounting recess 40C. The rear mounting recess 40A is configured to house a battery pack 44 to power the vehicle 10, and includes a connection point 42 configured to receive and establish electrical connection with the battery pack 44. The front and middle mounting recesses 40A,40B are not provided with connection points 42. Instead, these mounting recesses are configured to house back-up or spare battery packs 44. In this way, a user can conveniently transport two spare battery packs 44 on long journeys. On the other hand, where the scooter is only being used for a short journey, the user can choose to leave the front and middle mounting recesses 40A, 40B empty to minimise the weight of the vehicle 10. Alternatively, all three battery pack mounting recesses may be provided with connections 42 such that electrical power for powering the motor and other electrical components of the vehicle can be drawn from battery packs installed in the front and rear mounting recesses 40A,40B.

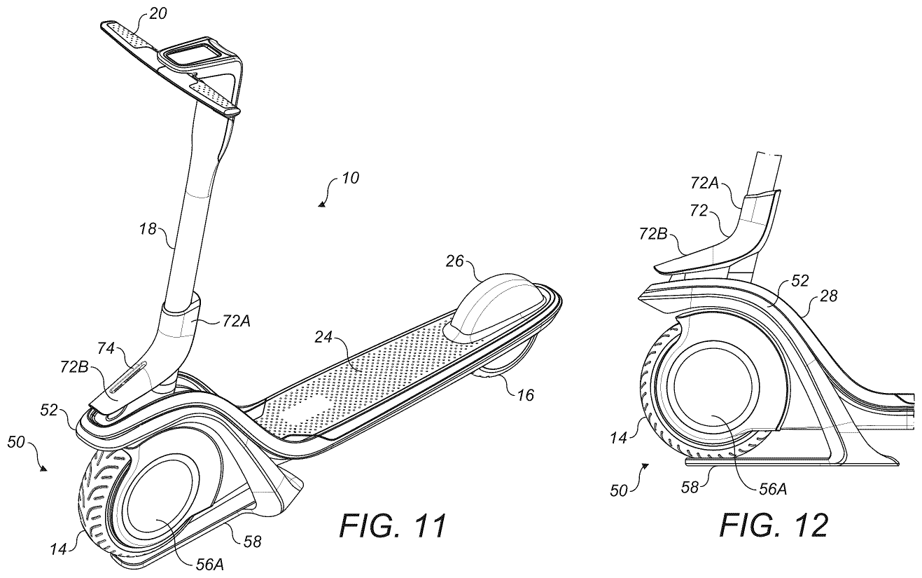

Referring now to FIGS. 11 to 14, charging of the battery pack 44 in the rear mounting recess 40C by connection of the vehicle 10 in a docking system 50 will be described.

Referring to FIGS. 11 to 14, the docking system 50 comprises a body which is complementary in shape to a front portion of the scooter. In particular, the body comprises a front extension-receiving portion 52 and a front wheel-receiving portion 54. The front extension-receiving portion 52 has a proximal end and a distal end and is shaped to receive and conform with the front extension 28 of the scooter. The front wheel-receiving portion 54 is shaped to receive the front wheel 14 of the scooter and comprises two side pieces 56A,56B and a wheel guide 58. The two side pieces 56A,56B extend from the front extension-receiving portion 52 on either side of the body. The wheel guide 58 has a proximal end and a distal end. The proximal end of the wheel guide 58 is connected to the proximal end of the front extension-receiving portion 52. The wheel guide 58 helps to align the front wheel 14 between the side pieces 56A,56B as the scooter is engaged within the docking system 50, and is configured such that the distal end of the wheel guide 58 sits underneath the front wheel 14 when the scooter is docked.

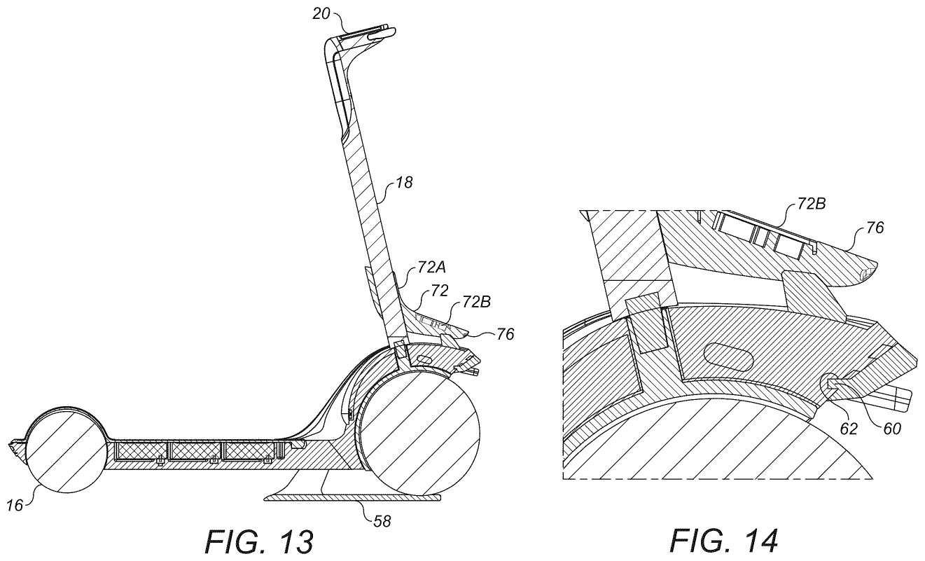

Referring now to FIGS. 13 and 14, it can be seen that the distal end of the front extension-receiving portion 52 is provided with a male electrical connector 60 (shown schematically in FIGS. 13 and 14). The distal end of the front extension 28 of the scooter is provided with a complementary female electrical connector 62 which is in electrical communication with the battery in the rear mounting recess 40A. As the scooter is docked in the docking system 50 by moving the front extension 28 into the front extension-receiving portion 52, the male electrical connector 60 of the docking system 50 engages within the female electrical connector 62 of the scooter.

In use, the docking system 50 is connected to mains power. A user then engages the vehicle 10 within the docking system 50, as shown in FIGS. 11 to 14, such that electrical power is provided to the battery pack 44 through the male connector in the front extension-receiving portion 52 of the docking system 50. In this way the battery pack 44 can be charged.

On the other hand, in embodiments in which all three of the battery pack mounting recesses 40A,40B,40C are provided with electrical connections 42, engagement of the vehicle 10 in the docking system 50 causes simultaneous charging of all battery packs installed in the mounting recesses 40A,40B,40C.

As well as enhancing the visibility of the scooter on the road (and, in the case of the footboard 24 lighting system, demarcating a safety zone on the running surface around the scooter), the lighting systems of the scooter are also provided with various functionalities for communicating with both the user of the scooter and other road users. These functionalities are controlled by the control module 38 housed in the compartment beneath the footboard 24. For this purpose, the control module 38 comprises a central processing unit (CPU) configured to receive and process various input signals. The CPU of the control module 38 is also operably connected to the controller of each LED strip and provides instructions to the controllers based on certain inputs.

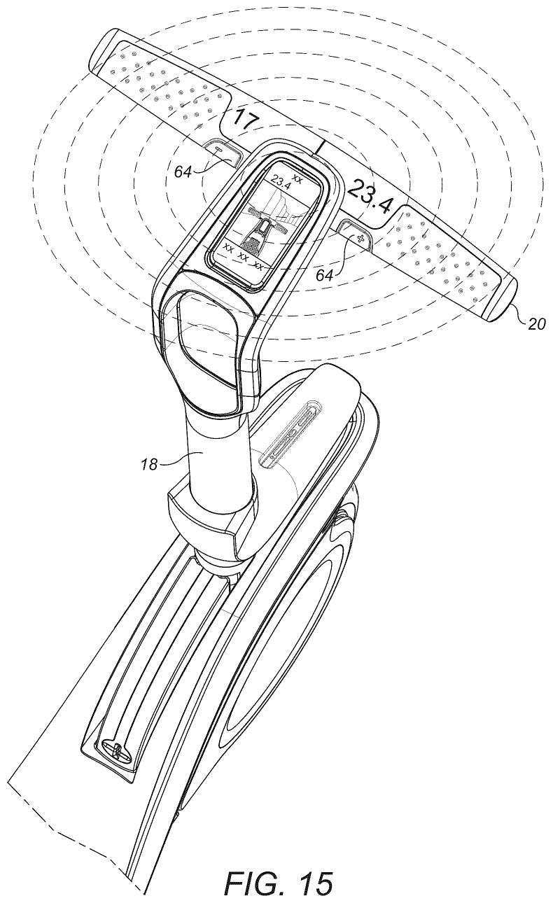

Referring to FIG. 15, one such communication functionality of the lighting systems comprises an indicator functionality which informs other road users of an intended manoeuvre to be made by the user of the scooter. In particular, the scooter is provided with a turn indicator circuit configured to receive inputs which indicate that the user intends to turn left or right. For this purpose, each handlebar 20 is provided with a user-operated turn indicator switch. Each switch comprises a sliding switch 64 arranged such that a user can easily operate the switch with a thumb or with the side of a hand whilst operating the scooter. The switches 64 are sliding switches, of the type well-known in the art. Each switch has an initial position adjacent a respective one of the handlebars, and an indicator position, relatively further away from the respective handlebar. The user operates the switch by sliding the same between the initial position and the indicator position. Alternatively, the switches may comprise latching push-buttons, of the type well-known in the art. In such alternative embodiments, the user operates the switch by depressing the push-button.

In use, when a user wishes to indicate that they are about to turn right, they simply slide the push button 64 on the right-hand handlebar 20 (relative to the direction of travel of the scooter) towards the right, into the indicator position. Moving the switch 64 into the indicator position causes the indicator circuit to send a signal to the control module 38 which then instructs the controller of the footboard LED strip to increase an intensity of light output from LEDs arranged on the righthand side of the footboard 24. At the same time, the control module 38 instructs the controller of the righthand handlebar LED strip to increase an intensity of light output from that LED strip.

After the manoeuvre has been completed, the user simply slides the switch 64 on the right-hand handlebar 20 back into the initial position to return the respective switch to its initial state. The indicator circuit then sends a signal to the control module 38 which instructs the controller of the footboard 24 LED strip and the controller of the righthand handlebar 20 LED strip to return the intensity of light output from the LED strips to an initial level.

Similarly, when the user wishes to indicate that they are about to turn left, they simply slide the indicator switch 64 on the left-hand handlebar 20 (relative to the direction of travel of the scooter) towards the left into the indicator position. Moving the switch 64 into the indicator position causes the indicator circuit to send a signal to the control module 38 which then instructs the controller of the footboard 24 LED strip to increase an intensity of LEDs arranged on the left-hand side of the footboard 24.

After the manoeuvre has been completed, the user simply slides the switch 64 on the left-hand handlebar 20 back into the initial position to return the respective switch to its initial state. The indicator circuit then sends a signal to the control module 38 which instructs the controller of the footboard LED strip and the controller of the lefthand handlebar LED strip to return the intensity of light output from the LED strips to an initial level.

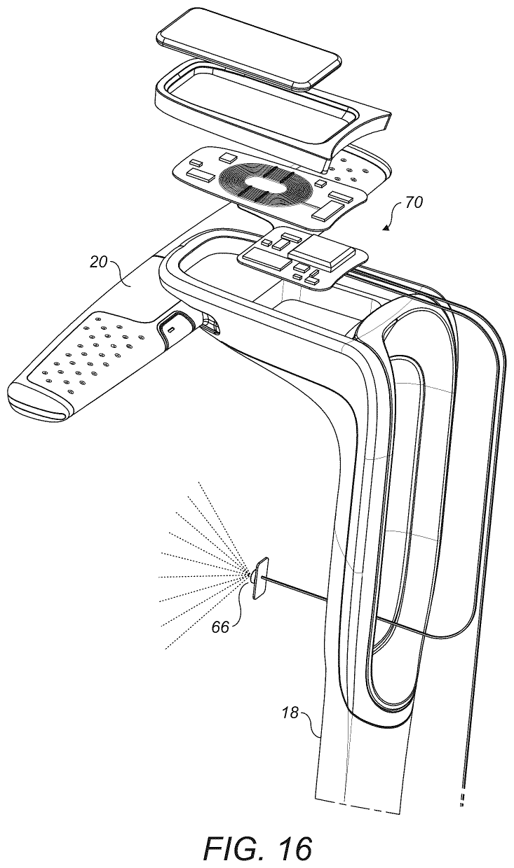

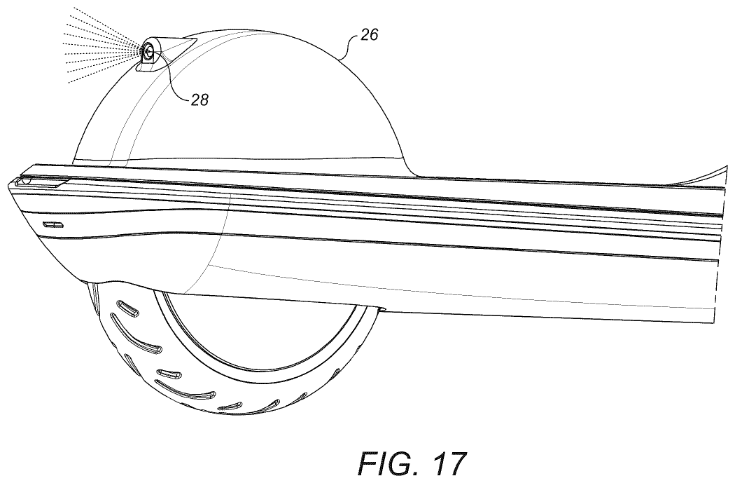

Referring to FIGS. 16 and 17, the scooter comprises front and rear cameras 66,68 configured to capture visual information relating to the scooter's environment. The front camera 66, shown in FIG. 16, is arranged in the steering column 18 and collects information from in front of the scooter. The rear camera 68, shown in FIG. 17, is arranged in the splashguard 26 of the rear wheel 16 and collects information from behind the scooter.

Referring in particular to FIG. 16, each of the front and rear cameras 66,68 are connected to an image processing system 70 located at a distal end of the steering column 18 behind the handlebar 20. Visual information captured by the front and rear cameras 66,68 is sent to the image processing system 70 which evaluates the information and detects if another vehicle 10 has come within a predetermined distance of the scooter. If a vehicle 10 is detected within the predetermined distance, the image processing system sends a signal to the control module 38 which then instructs the controllers of the LED strips to alter an output of the LEDs so as to provide a warning signal which warns the other road user that they have come too close to the scooter. For instance, the controllers may illuminate red diodes such that the strips output red coloured light. The controllers may also illuminate the red diodes for intermittent periods such that the diodes flash

The lighting systems of the scooter are also configured to provide a signal which indicates to the user that the scooter is correctly connected within the docking system 50 and that a battery pack 44 housed in the rear mounting recess 40A of the compartment is charging.

For this purpose, the vehicle 10 includes a battery pack monitoring system in communication with the control module 38. The battery pack monitoring system comprises a voltmeter configured to measure the voltage across the terminals of a battery pack 44 installed within the rear mounting recess 40A, and a processor. The processor is configured to detect that the voltage across the battery terminals measured by the voltmeter has exceeded a predetermined threshold. In various embodiments the predetermined threshold is a certain value above the open circuit voltage of the battery pack 44. For example, the predetermined threshold may be a value 1%, 2% or 5% higher than the open circuit voltage of the battery. This is because the voltage across the terminals of the battery pack 44 would not normally be expected to exceed the open circuit voltage unless the battery pack 44 was connected to an external voltage source.

If the processor determines that the voltage across the terminals of the battery pack 44 exceeds the predetermined threshold, it sends a signal to the control module 38 which instructs the controllers of the LED strips to alter the output of the LEDS so as to provide a visual signal that the battery pack 44 is charging. For instance, the controllers may illuminate green diodes on the strips such that the strips emit green light.

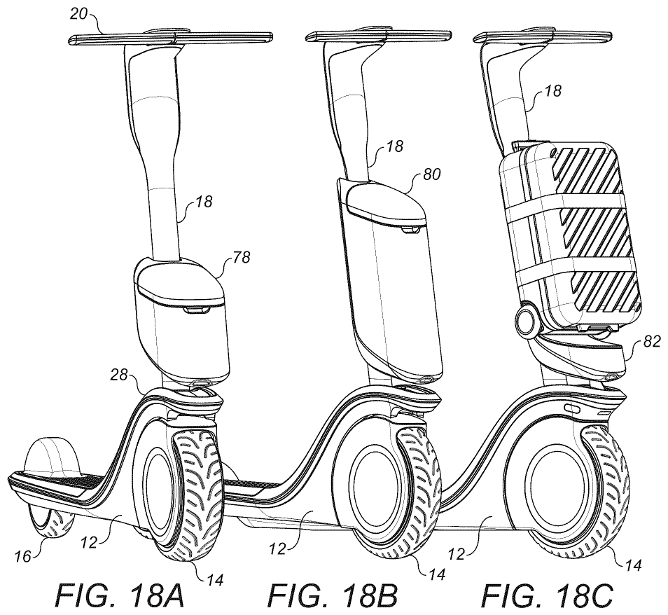

Referring now to FIGS. 1, 18A-C and 19, the scooter is designed to accommodate various accessories on the steering column 18. Referring to FIG. 1 in particular, for this purpose, a steering column adapter 72 is provided on the steering column 18. The steering column adapter 72 comprises a first portion 72A which fits around the steering column 18, and a second portion 72B protruding from a lower end of the first portion 72A. The second portion 72B projects over the front extension 28 of the main body 12 and forms a seat to accommodate the accessories.

As well as supporting the weight of the accessories on the scooter, the adapter 72 is also configured to provide electrical power from the battery to the accessories. As can be seen in FIG. 11, for this purpose, the adapter 72 is provided with a female electrical connector 74 configured to connect to a complementary male connector in the accessory. As can be seen best in FIGS. 10 and 15, to deliver electrical power from the battery to the adapter 72, the front extension 28 of the main body 12 is provided with a male electrical connector 76 configured as a “rhino horn” projecting upwards from the front extension 28. The male electrical connector 76 is electrically connected to the battery pack 44 housed in the rear mounting recess 40A of the compartment beneath the footboard 24. The lower surface of the second portion of the adapter 72 is provided with a female electrical connector 77 configured to receive and form an electrical connection with the male electrical connector 76 of the front region 22. The male electrical connector 76 of the front region 22 engages within the female electrical connector 77 on the underside of the adapter 72 as the steering column 18 is rotated into the steering position from the stowed position. In this way, the adapter 72 is electrically connected to the battery pack 44. As well as serving to transmit electrical power to the adapter 72, the male connector 76 also acts to support the weight of any accessory installed on the adapter 72, and thus resists any turning moment on the forward end of the second portion of the adapter 72 due to the weight of the accessory.

Referring to FIG. 18A, one accessory of the scooter is configured as a storage box 78. Although not depicted, the storage box 78 includes a male electrical connector on the underside thereof, which male electrical connector is configured to be received in the female electrical connector 74 in the adapter 72 to thereby transmit electrical power from the battery pack 44 to the storage box 78. The storage box 78 is configured as an electronic safe and has an electronic locking mechanism which receives power from the battery packs via the adapter 72.

In other embodiments, the storage box 78 is provided with an alarm system comprising a speaker. The alarm system can receive power from the battery packs via the adapter 72. The alarm system can generate audio signals which are output by the speaker to provide road users with an audible signal. This audible signal can be used in conjunction with visual signals output by the lighting signals.

In other embodiments, the storage box 78 may be specially designed for the storage of food items. In such embodiments, electrical power delivered to the storage box 78 from the battery pack 44 via the adapter 72 may be used by a heating and/or refrigeration unit to maintain food items within the storage box 78 at a desired temperature.

FIG. 18B shows an alternative storage box 80 which may be used instead of the storage box 80 described in connection with FIG. 18A. The storage box 80 of FIG. 18B is substantially the same as the storage box 80 of FIG. 18A except the storage box 80 of FIG. 18B is taller than the storage box 80 of FIG. 18A and thus has a larger capacity.

FIG. 18C shows a third type of accessory which may be used with the vehicle 10. The accessory of FIG. 18C is configured as a luggage shelf 82 which attaches to the adapter 72. The luggage shelf 82 has a seat portion which is longer and wider than the second portion of the adapter 72, and thus enables larger items, such as a small suitcase, to be supported on the vehicle 10.

Whilst the embodiments described above relate specifically to a battery powered electric scooter, the disclosure is not limited to electric scooters. The lighting systems described herein are applicable to other types of scooter, e.g. other forms of powered scooter.

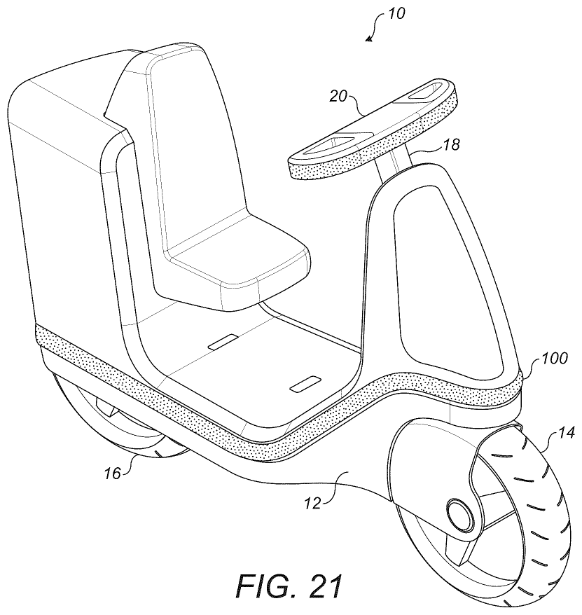

FIGS. 20 and 21 depict alternative embodiments of the vehicle 10 of the invention in which the vehicle 10 is implemented as an electric bicycle (“E-Bike”) and an electric cargo bike (“E-Cargo Bike”), respectively.

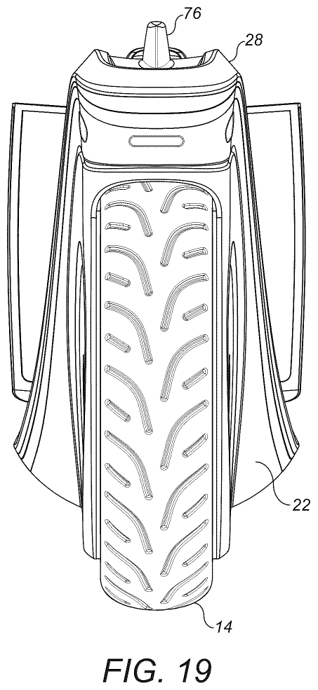

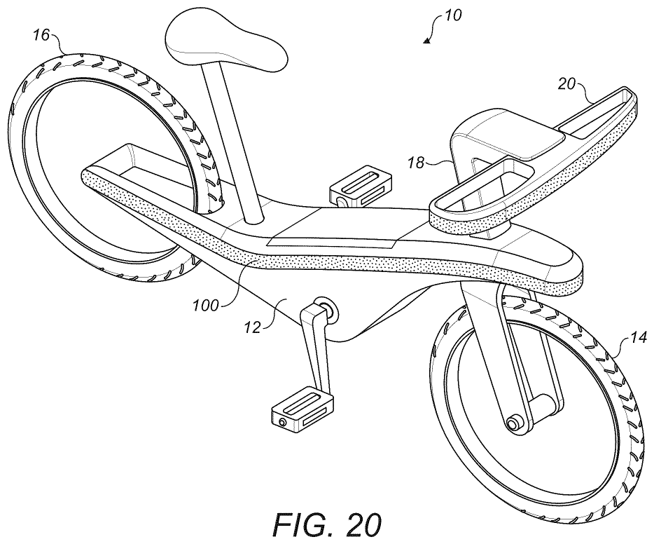

Each of the E-Bike and the E-Cargo Bike a main body 12, a front wheel 14, a rear wheel 16. Like the main body 12 of the scooter described with respect to FIGS. 1 to 19, the E-Bike and the E-Cargo Bike each includes a main body lighting system and a handlebar lighting system. The main body lighting system and the handlebar lighting system of each of the E-Bike and the E-Cargo Bike is configured substantially the same as those of the scooter described above with respect to FIGS. 2 to 7. The lighting systems of each of the E-Bike and the E-Cargo may be provided with any of the communication functionalities described above with respect to the lighting systems of the scooter.

For the embodiments which relate specifically to a scooter, such scooters may also include scooters of the type having multiple wheels on a common axis at the front and/or rear of the vehicle, similar to a tricycle or quad bike layout.

It will be understood that this disclosure relates to a wheeled road vehicle with a main body having a front end and a rear end and defining two opposing sides extending between the front end and the rear end. At least one front wheel is located toward the front end and at least one rear wheel is located toward the rear end. The vehicle has a lighting system, the lighting system including one or more light sources for defining a zone of illumination extending along at least a major portion of both sides of the footprint, and around the front end of the footprint.

For any of the foregoing embodiments, the vehicle may include any one of the following elements, alone or in combination with each other:

The lighting system can be configured to project light onto a running surface over which the road vehicle will travel in use, the lighting system being configured such that, in plan view, the light projected onto the running surface defines a zone of illumination on the running surface which extends around at least a portion of a perimeter of the footprint of the vehicle.

The vehicle footprint may define a longitudinal centre axis, wherein the zone of illumination on the running surface has a perimeter having a front end extending along the front end of the footprint, and opposing sides each extending along a respective one of the opposing sides of the footprint, wherein each side of the perimeter describes a line of constant distance from a longitudinal centre axis of the vehicle footprint. The front end of the perimeter of the zone of illumination of the running surface can describe a curve of constant radius. The perimeter of the zone of illumination on the running surface can also have a rear end extending along the rear end of the footprint; wherein the rear end of the perimeter can describe a curve of constant radius.

Each side of the perimeter can describe a line of constant distance, D, from the longitudinal centre axis of the vehicle footprint, wherein the radius of each of the curves described by the front and rear ends of the perimeter is also D; wherein the lighting system is configured such that distance D is adjustable.

The vehicle can further include a control unit, the control unit being configured to adjust the distance D dependent on one or more conditions relating to an environment in which the vehicle is operated. The wheeled road vehicle can further include one or more sensors, each sensor configured to monitor an input and provide a signal based on the input, and a control system configured to receive the inputs from the one or more sensors; wherein the control unit is part of a control system is further configured to adjust the distance D if one of the inputs is above or below a predetermined threshold, e.g. wherein the one or more sensors is configured for detecting a level of darkness and/or precipitation at the time of use of the vehicle, for adjusting the distance D accordingly (e.g. to increase the distance D is the sensed light level in the proximity of the vehicle is below a predetermined threshold, and/or if the sensed precipitation level in the proximity of the vehicle is above a predetermined threshold). In exemplary embodiments, the control system may include a look up table for determining the distance D dependent upon detected values from the one or more sensors.

In exemplary embodiments, the main body defines at least one groove for receiving an array of light emitting elements. Such a groove may extend along at least a major portion of each side of the main body. Such a groove may extend around at least a major portion of the front of the main body. Such a groove may extend around at least a major portion of the rear of the main body. In exemplary embodiments, the groove extends continuously around at least a major portion of the perimeter of the main body (e.g. along each side of the main body and around the front of the main body). In exemplary embodiments, the lighting system comprises an array of light emitting elements mounted within the or each groove.

A motor vehicle is also provided. The motor vehicle has a docking station for an electric scooter for charging the electric scooter, wherein the docking station is configured for charging the electric scooter. The electric scooter can be a vehicle in accordance with any of the embodiments described above.

1. A wheeled road vehicle comprising a main body having a front end and a rear end and defining two opposing sides extending between the front end and the rear end, wherein a front wheel is located toward the front end and a rear wheel is located toward the rear end; wherein the vehicle defines a footprint in plan view, the footprint having a front end, a rear end and opposing sides extending between the front end and rear end, further wherein the vehicle comprises a lighting system, the lighting system including one or more light sources for defining a zone of illumination extending along at least a major portion of both sides of the footprint and around the front end of the footprint.

2. A wheeled road vehicle according to claim 1, and wherein the zone of illumination forms an area of uniform illumination which extends along at least a major portion of both sides of the footprint and around the front end of the footprint.

3. A wheeled road vehicle according to claim 1, wherein the lighting system is configured to project light onto a running surface over which the road vehicle will travel in use, the lighting system being configured such that, in plan view, the light projected onto the running surface defines a zone of illumination on the running surface which extends around at least a portion of a perimeter of the footprint of the vehicle.

4. A wheeled road vehicle according to claim 3, wherein the zone of illumination on the running surface extends along at least a major portion of both sides of the footprint and around the front end of the footprint.

5. A wheeled road vehicle according to claim 3, wherein the zone of illumination on the running surface comprises an area of uniform illumination on the running surface, wherein the area of uniform illumination on the running surface extends along at least a major portion of both sides of the footprint and around the front end of the footprint.

6. A wheeled road vehicle according to claim 3, wherein the vehicle footprint comprises a longitudinal center axis, wherein the zone of illumination on the running surface has a perimeter having a front end extending along the front end of the footprint, and opposing sides each extending along a respective one of the opposing sides of the footprint, wherein each side of the perimeter describes a line of constant distance from a longitudinal center axis of the vehicle footprint, wherein the front end of the perimeter describes a curve of constant radius.

7. A wheeled road vehicle according to claim 6, wherein each side of the perimeter describes a line of constant distance, D, from the longitudinal center axis of the vehicle footprint, wherein the radius of each of the curves described by the front and rear ends of the perimeter is also D; wherein the lighting system is configured such that distance D is adjustable; wherein the vehicle further comprises a control unit, the control unit being configured to adjust the distance D dependent on one or more conditions relating to an environment in which the vehicle is operated; wherein the wheeled road vehicle further comprises one or more sensors, each sensor configured to monitor an input and provide a signal based on the input, and a control system configured to receive the inputs from the one or more sensors; and wherein the control unit is part of a control system and is further configured to adjust the distance D if one of the inputs is above or below a predetermined threshold.

8. A wheeled road vehicle according to claim 3, wherein the vehicle includes a main body defining front and rear ends of the vehicle, wherein the perimeter of the main body has a front end, a rear end and opposing sides extending between the front end and rear end, wherein the zone of illumination on the main body extends continuously along at least a major portion of both sides of the perimeter and around the front end of the perimeter; and wherein the lighting system comprises a reflector arrangement configured to reflect light from the one or more light sources upwards and/or outwards.

9. A wheeled road vehicle according to claim 1, wherein the main body defines a groove which extends along a major portion of each side of the main body and around the front of the main body, wherein the lighting system comprises an array of lighting emitting elements arranged within the groove for directing light emitted from the light emitting elements onto the running surface over which the road vehicle will travel in use, to define the zone of illumination on the running surface; wherein the groove is tilted at an angle θ in the range 20 to 90 degrees to the horizontal when the road vehicle is oriented for use to travel on the running surface, such that light from the light emitting elements is directed outwards from a perimeter of the road vehicle and downwards onto the running surface.

10. A wheeled road vehicle according to claim 9, wherein a height y(x) of the groove above a running surface when the road vehicle is oriented for use to travel on the running surface varies with a position x along a longitudinal axis of the groove; further wherein a luminous flux Φ(x) emit at the array at position x along the groove varies as a function f(y(x)) of the height y(x) of the groove above the running surface at that position x, such that the zone of illumination on the running surface consists of an area of uniform light intensity; wherein the function f(y) is defined by the below formula:
(Add)=f(y(x))=A(y(x))²
where A is a constant.

11. A road vehicle according to claim 9, wherein the zone of illumination on the running surface has a perimeter having a front end extending around the front end of the footprint, a rear end extending around the rear end of the footprint and opposing sides each extending round a respective one of the opposing sides of the footprint;
wherein the groove is tilted at an angle θ(x) of between 20 and 90 degrees to the horizontal when the road vehicle is oriented for use to travel on the running surface, such that light from the light emitting elements is directed outwards from a perimeter of the road vehicle and downwards onto the running surface;
wherein a height y(x) of the groove above a running surface when the road vehicle is oriented for use to travel on the running surface varies with a position x along a longitudinal axis of the groove; and
the angle θ(x) at which the groove is tilted to the horizontal at position x increases as the height y(x) of the groove above the running surface increases, such that each side of the perimeter describes a line of constant distance D from a longitudinal center axis of the vehicle footprint; and the front and rear ends of the perimeter each describes a curve of constant radius, D.

12. A road vehicle according to claim 9, wherein the lighting system further comprises a lens arrangement, further wherein the lens arrangement is arranged to focus light from the groove on to the running surface; wherein a height y(x) of the groove above a running surface when the road vehicle is oriented for use to travel on the running surface varies with a position x along a longitudinal axis of the groove; wherein a focal length F(x) of the lens arrangement varies along the longitudinal axis of the groove; wherein the focal length F(x) of the lens at a position x along the groove increases as the height y(x) of the groove above a running surface at that position; and wherein the focal length F(x) of the lens at a position x along the groove increases in proportion to the height y(x) of the groove above a running surface at that position.

13. (canceled)

14. A wheeled road vehicle according to claim 10, wherein the main body of the vehicle comprises a reflector arrangement arranged within or adjacent the groove for reflecting light from the one or more light sources upwards and/or outwards; wherein the lighting system and the reflector arrangement are configured to cooperate so as to create a zone of illumination on the main body extending continuously around at least a portion of a perimeter of the main body; wherein the perimeter of the main body has a front end, a rear end and opposing sides extending between the front end and rear end, wherein the zone of illumination on the main body extends continuously along at least a major portion of both sides of the perimeter and around the front end of the perimeter.

15. A wheeled road vehicle according to claim 1, further comprising:
a control system; and
a sensor configured to detect whether an object is within a predefined distance of the road vehicle, and send a signal to the control system upon detection of an object within the predefined distance;
wherein the control system is configured to adjust an output of the one or more light sources to provide a light signal to road users upon receipt of the signal from the sensor.

16. A wheeled road vehicle according to claim 1, further comprising:
a control system configured to receive a first user input indicative of a maneuver to be made by the road vehicle;
wherein the control system is further configured to adjust an output of the one or more light sources upon receipt of the first user input to thereby provide a light signal which warns other road users of the intended maneuver.

17. A wheeled road vehicle according to claim 1, further comprising a control system, wherein the road vehicle is configured to connect to a docking system, further wherein the control system is configured to detect that the road vehicle has been connected to the docking system and adjust an output of the one or more light sources to signal to a user that the road vehicle is connected to the docking system.

18. A wheeled road vehicle according to 15, wherein adjusting an output of the light sources comprises at least one of adjusting a brightness of the one or more light sources and changing a color of light emitted from the one or more light sources.

19. A wheeled road vehicle according to any preceding claim, wherein the vehicle is in the form of a scooter of the kind comprising:
a footboard for a user to stand on during movement of the vehicle, the footboard having a front end and a rear end;
a front wheel toward the front end of the footboard, the front wheel being rotatable relative to said footboard about a first wheel axis; and
a rear wheel toward the rear end of the footboard, the rear wheel being rotatable relative to said footboard about a second wheel axis;
wherein the front wheel is movable relative to a steering axis for steering the vehicle.

20. A motor vehicle with a docking station for an electric scooter for charging the electric scooter, wherein the docking station is configured for charging the electric scooter; wherein the electric scooter comprises a main body having a front end and a rear end and defining two opposing sides extending between the front end and the rear end, wherein a front wheel is located toward the front end and a rear wheel is located toward the rear end; wherein the vehicle defines a footprint in plan view, the footprint having a front end, a rear end and opposing sides extending between the front end and rear end, further wherein the vehicle comprises a lighting system, the lighting system including one or more light sources for defining a zone of illumination extending along at least a major portion of both sides of the footprint and around the front end of the footprint; and a control system, wherein the electric scooter is configured to connect to the docking station, further wherein the control system is configured to detect that the electric scooter has been connected to the docking station and adjust an output of the one or more light sources to signal to a user that the electric scooter is connected to the docking station.

21. A wheeled road vehicle according to claim 18, wherein the road vehicle is a battery-powered electric scooter having at least one battery and at least one electric motor, and wherein at least one wheel of the electric scooter is configured to be driven by the electric motor via power received from the battery.
